(19) United States
(12) Patent Application Publication
(10) Pub. No.: US 2003/0212566 A1
(43) Pub. Date: Nov. 13, 2003

(54) Methods and systems for assisting with Do-Not-Call compliance

(75) Inventors: Scott Fergusson, Fort Wayne, IN (US); Tom Rozman, Edina, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: Investigo Corporation

(21) Appl. No.: 10/140,095

(22) Filed: May 7, 2002

(51) Int. Cl. G06F 17/60

(52) U.S. Cl. 705/1

(57) ABSTRACT

Methods and systems are provided for assisting organizations in complying with Do-Not-Call laws. The system gains access to one or more Do-Not-Call (DNC) listings, and notifies a telemarketer or other sales person when a prospective client should not be called. Various methods are also disclosed for determining when a prospective client can be contacted despite being listed on a DNC list.

### CROSS-REFERENCE TO CO-PENDING PATENT APPLICATIONS

This Application is related to co-pending U.S. patent application Ser. No. 09/917,120, filed Jul. 27, 2001, entitled “Methods and Systems for Assisting Financial Services Firms and Their Representatives”, U.S. patent application Ser. No. 09/917,447, filed Jul. 27, 2001, entitled “Methods And Systems For Providing A Measure Of Supervision Over The Activities Of Representatives Of A Business” and U.S. patent application Ser. No. 09/916,951, filed Jul. 27, 2001, entitled “Methods and Systems for Monitoring the Efficacy of a Marketing Project”, all of which are incorporated herein by reference.

### BACKGROUND

The present invention relates generally to methods and systems for assisting organizations, and more particularly, to methods and systems for assisting organizations with Do-Not-Call compliance.

Direct marketing is a tool commonly used to market products and services directly to consumers. In many cases, direct marketing takes the form of telemarketers or other sales people obtaining and calling prospective clients at home. While this can be an effective marketing strategy, many consumers have come to dislike receiving such calls.

In an attempt to curb such marketing practices, congress passed the Telephone Consumer Protection Act (TCPA) in 1991. The TCPA restricts telemarketers and other sales people from calling residential numbers unless the telemarketer has instituted written policies and procedures for maintaining an internal “Do Not Call” list that identifies those consumers who request not to receive further solicitations. In 1994, congress passed the Telemarketing and Consumer Fraud Act and Abuse Protection Act, which specify that telemarketers and other sales people may not call anyone who requests not to be contacted, and that “sellers and telemarketers” must maintain internal Do-Not-Call databases of individuals requesting “do not call” status. The act also allows for fines of $10,000 per violation. Both the Federal Trade Commission (FTC) and the Federal Communications Commission (FCC) have roles in enforcing this legislation.

As part of its charge to enforce the Telephone Consumer Protection Act (TCPA) of 1991, the Federal Communications Commission (FCC) issued a ruling stipulating that all persons (telemarketers) must be trained concerning cold calling regulations and the existence of the “Do Not Call” list, and that persons requesting that no further cold calls be received must be recorded on the “Do Not Call” list and a procedure must be in place to accomplish this. The Federal Trade Commission FTC also issued what is known as the Telemarketing Sales Rule, which implements the Telemarketing and Consumer Fraud and Abuse Prevention Act of 1994. Notable, the Telemarketing Sales Rule does not prohibit any attorney general or other authorized state official from proceeding in State court on the basis of an alleged violation of any civil or criminal statute of such State. Many states have already passed, or are the process of passing, Do-Not-Call legislation.

State Do-Not-Call legislation has produced a wide variety of results, not only in form but also in substance. For example, many state Do-Not-Call laws provide for certain exemptions for some businesses such as charities, debt collectors, nonprofit organizations, state licensed professionals such as attorneys, stockbrokers, insurance agents, mortgage brokers and/or real estate brokers and agents. However, the exemptions can vary significantly depending on the state. Similarly, many states allow a business to contact a person that is on the state's Do-Not-Call list if the business has a prior or existing relationship with the person. However, what constitutes a “prior or existing relationship” can vary widely depending on the state.

In some cases, the federal and state laws may be inconsistent. For example, a state may provide an exemption for securities dealers. However, in 1995, the Securities and Exchange Commission (SEC) ruled that securities dealers must comply with the various telemarketing acts and, therefore, must maintain centralized “do not call” lists. Accordingly, and in this example, a securities dealer who violates a “do not call” request while making an interstate call may be in violation of federal law but not state law. In other cases, federal law and state law may both apply, and the securities dealer may be subject to both federal and state investigations and penalties. The various laws in this area are changing rapidly, which makes it even more difficult to maintain Do-Not-Call compliance.

### SUMMARY

The present invention provides methods and systems for assisting organizations in complying with various Do-Not-Call laws. In one illustrative embodiment, a system is provided that gains access to one or more Do-Not-Call (DNC) listings. The DNC listings may contain a number of entries that identify consumers that do not want to be called by telemarketers or other sales people. In many cases, the DNC listings may be provided by government agencies, such as state and/or federal government agencies. An internal DNC listing may also be accessed.

During use, a telemarketer or other sales person may provide a name or other identifier of one or more prospective clients to the system. The system may identify which of the one or more prospective clients provided by the telemarketer or other sales person have a corresponding entry in at least one of the DNC listings. Those prospective clients that have a corresponding entry in at least one of the DNC listings may be referred to as DNC prospective clients. In some embodiments, the system may indicate to the telemarketer or other sales person that the identified DNC prospective clients should not be contacted.

Rather than reporting that all identified DNC prospective clients should not be contacted, it is contemplated that the system may perform additional processing to determine which of the DNC prospective clients, if any, can be contacted by the telemarketer or other sales person and still maintain Do-Not-Call compliance. For example, and as noted above, some of the DNC listings may have one or more exemptions that allow at least some of the DNC prospective clients to be contacted by the telemarketer or other sales person. In one illustrative embodiment, the system may determine if the telemarketer or other sales person, and/or the organization represented by the telemarketer or other sales person, has an existing or prior relationship with the DNC prospective client. This may be accomplished by, for example, gaining access to one or more databases that identify existing and/or former clients of the telemarketer or other sales person, and/or the organization represented by the telemarketer or other sales person. The database may include one database, or several databases, as desired. For example, for some organizations, several databases may be accessed, each associated with a different business unit, division, or the like.

The system may then compare the identified DNC prospective clients with those clients that have an existing or prior relationship with the telemarketer or other sales person, and/or the organization represented by the telemarketer or other sales person. If an existing or prior relationship exists, the system may then indicate to the telemarketer or other sales person that the identified DNC prospective clients may be contacted.

As noted above, what constitutes a “prior or existing relationship” can vary widely depending on the state. As such, and in some embodiments, the system may mine the one or more databases to determine values that can be used to help determine the nature or status of the prior or existing relationship with the organization. For example, the system may mine the one or more databases to determine the length of time since the client transacted business with the organization, whether the client has dealt with the organization itself, or a sub- or related-organization, the types of transactions or contact made, whether and what type of accounts the client has or had with the organization, whether the client has an outstanding balance on any accounts within the organization, etc.

In some embodiments, the system may also reference one or more parameters that relate to selected exemptions, such as the prior or existing relationship exemption of some DNC listings. Each of the parameters may have one or more values that reflect or define whether an exemption is satisfied. For example, to help determine whether a valid prior existing relationship exists, the parameters may include one or more values that denote that if a client transacted business with the organization within the past year, a prior or existing relationship exists. The system may apply the parameter values to the values mined from the one or more databases to determine, if for a particular client, a prior or existing relationship exists. Because the definition of when a prior or existing relationship exists may differ depending on the state, different parameter values may be set for each of the state DNC listings, as desired.

In some embodiments, the parameter values may be set by a compliance authority or the like within the organization. When so provided, each organization may separately define when an exemption is satisfied. Determining when an exemption is satisfied can depend on a number of factors including, for example, the business that the organization is in, the risk tolerance of the organization, and well as many factors.

In some cases, the various DNC laws only prevent an organization from contacting the DNC prospective clients at home and via the phone. As such, and in some embodiments of the present invention, the system may determine contact information for some or all of the DNC prospective clients other than the DNC prospective client's home phone number. In some cases, the limited information about the DNC prospective client can be provided to one or more databases that return additional contact information. The one or more databases may include, for example, a phone company database, or other database. In one example, the phone number of the DNC prospective client can be extracted from the DNC listing, and provided to a reverse phone number lookup database that returns the home address of the DNC prospective client. Other contact information that can be derived may include, for example, the work phone number, e-mail address or other contact information of the DNC prospective client. The system may provide the other contact information to the telemarketer or other sales person, as desired. In some embodiments, the system may help generate a mailing or an e-mail, such as with a mail merge function or the like, that can then be sent to the DNC prospective client.

Some DNC laws require that select information must be recorded for each call, and saved for a period of time in case of an audit or other investigation. In one illustrative embodiment, the system of the present invention may help the telemarketer or other sales person record and save the required information. For example, before initiating a call, the system may display a new account worksheet or the like. The new account worksheet may include, for example, the prospective client's name, phone number, state of residence, whether the prospective client is on a DNC listing, and/or other information, as desired. The new account worksheet may also include the script that is used by the telemarketer or other sales person during the call. A notes region may also be provided, which may accept notes recorded by the telemarketer or other sales person during or after the call. In some embodiments, a selection indicator may also be provided, which when selected, may automatically add the prospective client's information to an internal DNC listing. The notes, an identification of the telemarketer or other sales person, the script used, the date of contact, and/or any other relevant information may also be stored. In some cases, the information is stored for at least the time period prescribed by the appropriate DNC laws.

During use, the telemarketer or other sales person may contact the prospective client and verbalize at least part of the script. In the event that the prospective client indicates he/she want to be placed on a DNC list, the telemarketer or other sales person may record one or more notes relative to the prospective client contact and select the DNC selection indicator. The system may then add the prospective client's name to an internal DNC listing, and store any other relevant information in a database for at least the time period prescribed by the appropriate DNC laws.

In some cases, the DNC listings are updated and released on a regular basis, such as monthly or quarterly. An updated DNC listing may include new names that correspond to people that have recently subscribed to the DNC listing. Likewise, an updated DNC listing may be missing names that were present in the previous DNC listing. The missing names may correspond to those people that failed to re-subscribe to the DNC listing. In many instances, the updated DNC listing is made available before it becomes effective. This grace period is used to give organizations time to distribute and react to the updated DNC listing.

It is contemplated that the system of the present invention may compare a previous DNC listing to an updated DNC listing, and identify those names that have just been added to the updated DNC listing. This may be done after the updated DNC listing is released but before the grace period expires. Once identified, those prospective clients that were newly added to the updated DNC listing can be contacted until the grace period expires. In some cases, a high priority can be assigned to at least some of the prospective clients for contact by the organization before the grace period expires.

In another illustrative embodiment, the system of the present invention may compare the previous DNC listing with the updated DNC listing to identify those prospective clients that are missing from the updated DNC listing. In some cases, a high priority can be assigned to at least some of the identified prospective clients that are missing from the updated DNC listing for contact by the organization.

### BRIEF DESCRIPTION OF THE DRAWINGS

FIG. 1 is a block diagram showing the architecture of an illustrative system for assisting financial services firms and their representatives efficiently managing their businesses and enhancing Do-Not-Call compliance;

FIG. 2 is an illustrative block diagram of the DNC control block of FIG. 1;

FIG. 3 is a flow diagram showing an illustrative method in accordance with the present invention;

FIG. 4 is a screen shot of an illustrative window that may be displayed by the Broker/Dealer Interface and Control Block of FIG. 1;

FIG. 5 is a screen shot of an illustrative window that may be displayed after determining that a prospective client's phone number can be called;

FIG. 6 is a screen shot of an illustrative window that may be displayed after determining that a prospective client's phone number should not be called;

FIG. 7 is a screen shot of an illustrative window that may be used to add a prospective client's phone number to an internal DNC listing;

FIG. 8 is a screen shot of an illustrative window that may be used to upload a listing of prospective clients and to check the client listing against one or more DNC listings;

FIG. 9 is a screen shot of an illustrative window that may be displayed after a list of prospective clients has been submitted to the system and checked against one or more DNC listings;

FIG. 10 is a screen shot of an illustrative window that may be displayed to identify high priority prospective clients;

FIG. 11 is a screen shot of an illustrative New Account Worksheet that may be displayed when a telemarketer or other sales person is going to make a call to a prospective client;

FIG. 12 is a flow diagram showing an illustrative method for contacting prospective clients;

FIG. 13 is a screen shot of an illustrative supervisor controls window that may be used to set one or more parameter values to help define which DNC prospective clients can be contacted;

FIG. 14 is a flow diagram showing an illustrative method for identifying which DNC prospective clients can be contacted by a representative of an organization; and

FIG. 15 is a block diagram showing an illustrative embodiment that blocks phone calls to DNC prospective clients that should not be contacted.

### DESCRIPTION

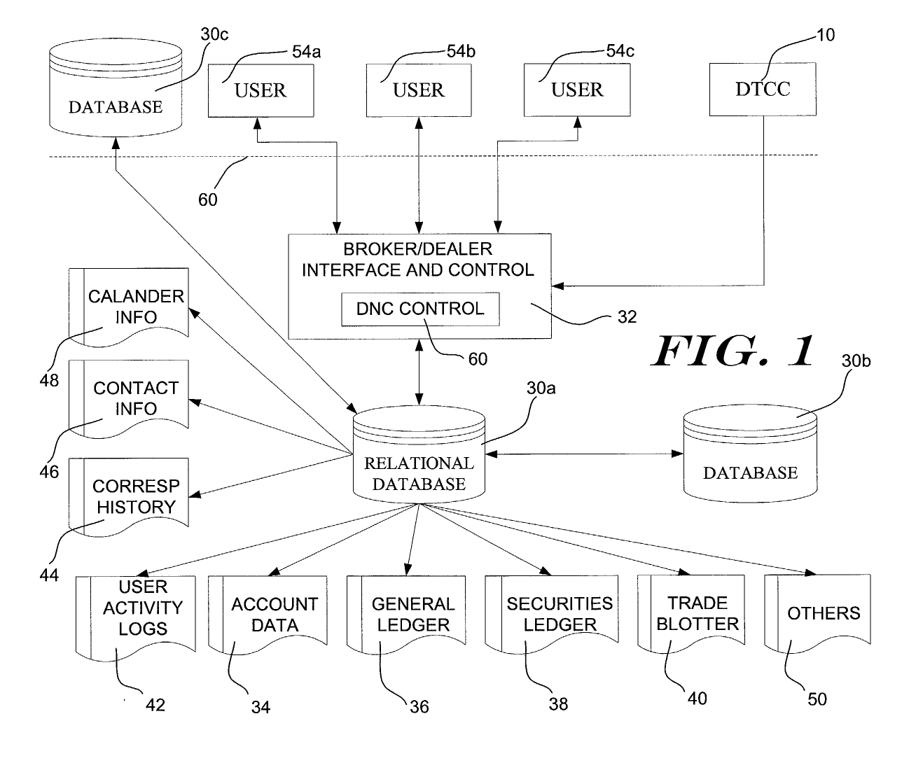

FIG. 1 is a schematic diagram showing an illustrative system for assisting financial services firms and their representatives in efficiently managing their businesses and enhancing Do-Not-Call compliance. The illustrative system shown in FIG. 1 is directed toward financial services firms such as Clearing Broker Dealers 12, Correspondent Broker Dealers 14a and 14b, Affiliate Broker Dealers 20 (see FIG. 1), or other financial services firms such as banks, insurance companies, consumer finance organizations, wire houses, etc. More generally, however, the present invention is applicable to any firm, business or organization that has representatives, and may be useful in efficiently managing their businesses and enhancing Do-Not-Call compliance.

The illustrative system uses a database 30a, which is preferably a relational database such as a Microsoft Access®, Microsoft SQL Server 2000®, Oracle 9i®, etc. In some embodiments, the system may also access other databases, such as databases 30b and 30c. Database 30b is shown as another local database, and database 30c is shown as a remote database. Multiple local and/or remote databases may be used by the system, if desired.

The broker/dealer interface and control block 32 provides an interface between the databases 30a-c and the users 54A, 54B, and 54C of the system. The users 54A, 54B, and 54C may be any type of users, but in the illustrative embodiment, are registered representatives and/or sales assistants. In a preferred embodiment, the broker/dealer interfacing control block 32 and relational database 30a (and 30b-c if desired) operate on one or more servers connected to a number of client systems through the World Wide Web (WWW). The users 54A, 54B and 54C preferably access the broker/dealer interface and control block 32 using the client systems. The server functions are generally shown below dashed line 60, and the client functions are generally shown above dashed line 60. While the preferred embodiment allows the users 54A, 54B and 54C to access the broker/dealer interface and control block 32 via the WWW, other embodiments allow the users 54A, 54B and 54C to access the broker/dealer interface control block 32 in any number of ways including, for example, through an intranet, a LAN, a direct connection, or any other connection mechanism or means.

To receive pricing data and to clear trades, the broker/dealer interface and control block 32 may be connected to the DTCC 10 and/or other services. It is contemplated that these connections may be via the WWW, an intranet, a LAN, a direct connection, or any other connection means.

In the illustrative embodiment, the relational database 30a includes a number of data files (or entries) to support the activities of users 54A, 54B and 54C. In some embodiments, some of these data files and/or additional data files are provided in databases 30b and 30c. Some illustrative data files include customer account data 34, general ledger data 36, securities ledger data 38, trade blotter data 40, user activity logs 42, customer correspondence history logs 44, customer contact information 46, calendaring information 48, and others 50. The account data file 34 preferably identifies each customer account, and the contents of each account. A customer account may include, for example, a customer account number, current and past holdings of the account, investment objectives of the account, personal information about the customer including the customer's name, address, interests, etc.

The general ledger data file 36 preferably stores a general ledger for the broker dealer firm. The securities ledger 38 preferably records each buy and sell executed by the broker dealer firm. The trade blotter data file 40 preferably stores each trade executed by the broker dealer firm. The user activity log data file 42 preferably stores information relating to each user's activity on the system. The correspondence history data file 44 preferably records the correspondence history between each representative and their customers. The contact information data file 46 preferably stores contact information for each customer including, for example, customer name, address, phone number, fax number, e-mail address, etc. The calendaring information data file preferably records appointments as well as other items provided by the representatives.

A further description of the illustrative system shown in FIG. 1 can be found in co-pending U.S. patent application Ser. No. 09/917,120 filed Jul. 27, 2001, entitled “Methods and Systems for Assisting Financial Services Firms and Their Representatives”, U.S. patent application Ser. No. 09/917,447, filed Jul. 27, 2001, entitled “Methods And Systems For Providing A Measure Of Supervision Over The Activities Of Representatives Of A Business” and U.S. patent application Ser. No. 09/916,951, filed Jul. 27, 2001, entitled “Methods and Systems for Monitoring the Efficacy of a Marketing Project”, all of which are incorporated herein by reference.

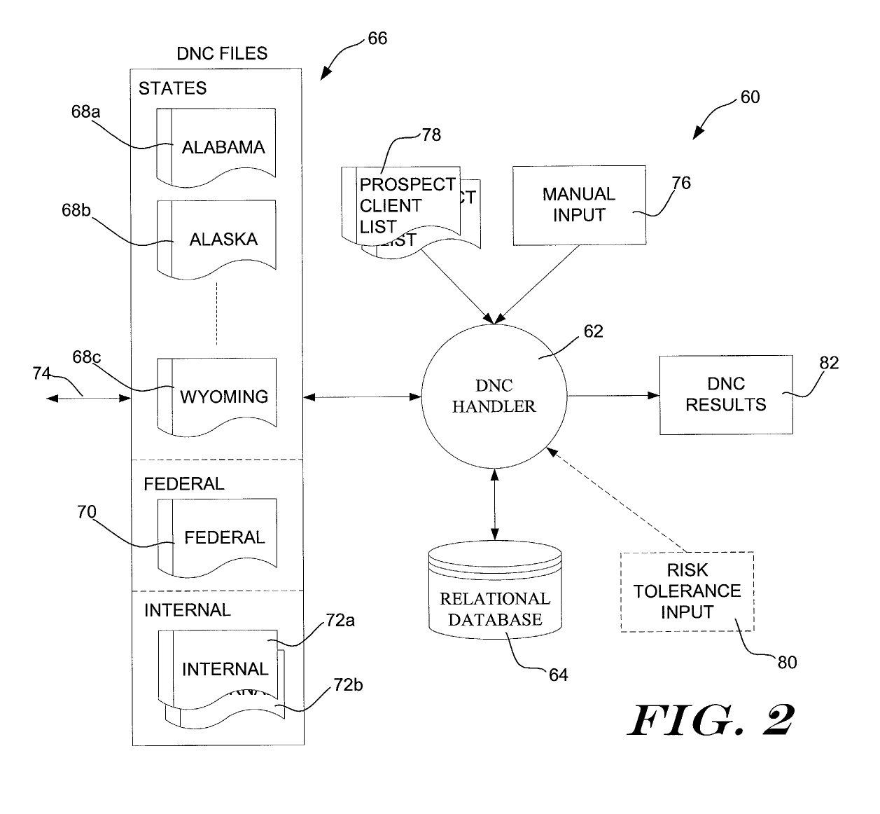

The Broker/Dealer Interface and Control block 32 may include a Do-Not-Call (DNC) control block 60. FIG. 2 is an illustrative block diagram of the DNC control block 60 of FIG. 1. Referring to FIG. 2, the illustrative DNC control block 60 includes a DNC handler block 62 and a relational database 64. The relational database 64 may be part of relational database 30a, 30b and/or 30c of FIG. 1, or may be a separately provided database, as desired.

The DNC handler block 62 gains access to one or more Do Not Call (DNC) listings or files, generally shown at 66. The DNC listing or files may include state DNC listings or files 68a, 68b, 68c, one or more federal DNC listings or files 70, and/or one or more internal DNC listings or files 72a and 72b. In some embodiments, the state and/or federal DNC listings or files 68a, 68b, 68c, 70, are periodically received from appropriate governmental agencies or offices via the Internet 74 or other communications system, and stored in relational database 64. In some cases, the state and/or federal DNC listings or files 68a, 68b, 68c, 70 are preprocessed into a common format after they are received. Many states currently make updated DNC listings or files available on a monthly or quarterly basis. The update schedule for the updated DNC listings or files can very between states. Thus, in some embodiments, the update schedule for each state is stored in relational database 64, and the DNC handler block 62 retrieves the appropriate updated DNC listings or files according to that schedule.

The DNC listings or files 68a, 68b, 68c, 70, 72a and 72b may contain a number of entries that identify consumers that do not want to be called by telemarketers or other sales people. Many states have a registration or subscription procedure, which allows residents to subscribe to the state's DNC listing.

The illustrative DNC handler block 62 may receive a name, phone number or other identifier of one or more prospective clients, which may be provided by a representative of an organization. In the illustrative embodiment, the DNC handler block 62 may receive this information manually via a manual input interface 76. Alternatively, or in addition, the DNC handler block 62 may receive information via one or more prospective client listings 78. In some embodiments, the prospective client listing 78 is a list purchased or otherwise obtained from one or more list sources, such as direct marketing companies or the like.

Once received, the DNC handler block 62 may identify which of the one or more prospective clients have a corresponding entry in at least one of the DNC listings 68a, 68b, 68c, 70, 72a and 72b. Those prospective clients that have a corresponding entry in at least on of the DNC listings 68a, 68b, 68c, 70, 72a and 72b may be referred to as DNC prospective clients. In some embodiments, the DNC handler block 62 may indicate to the telemarketer or other sales person that the identified DNC prospective clients should not be contacted.

Rather than indicating that all identified DNC prospective clients should not be contacted, it is contemplated that the DNC handler block 62 may perform additional processing to determine which of the DNC prospective clients, if any, can be contacted by the telemarketer or other sales person and still maintain Do-Not-Call compliance. For example, and as noted above, some of the DNC listings 68a, 68b, 68c, 70, 72a and 72b may have one or more exemptions that allow at least some of the DNC prospective clients to be contacted by the telemarketer or other sales person.

In one illustrative embodiment, DNC handler block 62 may determine if the telemarketer or other sales person, and/or the organization represented by the telemarketer or other sales person, has an existing or prior relationship with the DNC prospective client. This may be accomplished by, for example, gaining access to one or more databases, such as database 30a, 30b and/or 30c of FIG. 1, that identify existing and/or former clients of the telemarketer or other sales person, and/or the organization represented by the telemarketer or other sales person. In some cases, several databases may be accessed, each associated with a different business unit or the like of the organization.

The DNC handler block 62 may then compare the identified DNC prospective clients with those clients that have an existing or prior relationship with the telemarketer or other sales person, and/or the organization represented by the telemarketer or other sales person. If an existing or prior relationship exists, the DNC handler block 62 may indicate to the telemarketer or other sales person that the identified DNC prospective clients may be contacted.

As noted above, what constitutes a “prior or existing relationship” can vary widely depending on the state. As such, and in some embodiments, the DNC handler block 62 may mine the one or more databases, such as database 30a, 30b and/or 30c of FIG. 1, to determine values that can be used to help determine the nature or status of the prior or existing relationship with the organization. For example, the DNC handler block 62 may mine the one or more databases 30a, 30b and/or 30c to determine the length of time since the prospective client transacted business with the organization, whether the prospective client has dealt with the organization itself, or a sub- or related-organization, the types of transactions or contact made, whether and what type of accounts the prospective client has or had with the organization, whether the prospective client has an outstanding balance on any accounts within the organization, etc.

In some embodiments, the DNC handler block 62 may also reference one or more parameters that relate to selected exemptions, such as the prior or existing relationship exemption. Each of the parameters may have one or more values that reflect or define whether an exemption is satisfied. For example, to help determine whether a valid prior or existing relationship exists, the one or more parameters may have values that define that if a client transacted business with the organization within the past year, a prior or existing relationship exists in a particular state. The DNC handler block 62 may apply the parameter values to the values mined from the one or more databases to determine, if for a particular client, a prior or existing relationship exists. Because the definition of when a prior existing relationship exists may differ depending on the state, different parameter values may be set for each of the state DNC listings 68a, 68b and 68c, as desired.

In some embodiments, the parameter values may be set by a compliance authority or the like within the organization. Risk Tolerance Input block 80 may be used to set the parameter values. When so provided, each organization may separately define when an exemption is satisfied. Determining when an exemption is satisfied can depend on a number of factors including, for example, the business that the organization is in, the risk tolerance of the organization, and well as many others factors.

The DNC handler block 62 may provide DNC results as shown at 82. In one illustrative embodiment, the DNC results 82 may indicate which prospective clients provided via interfaces 76 and/or 78 can and/or cannot be contacted.

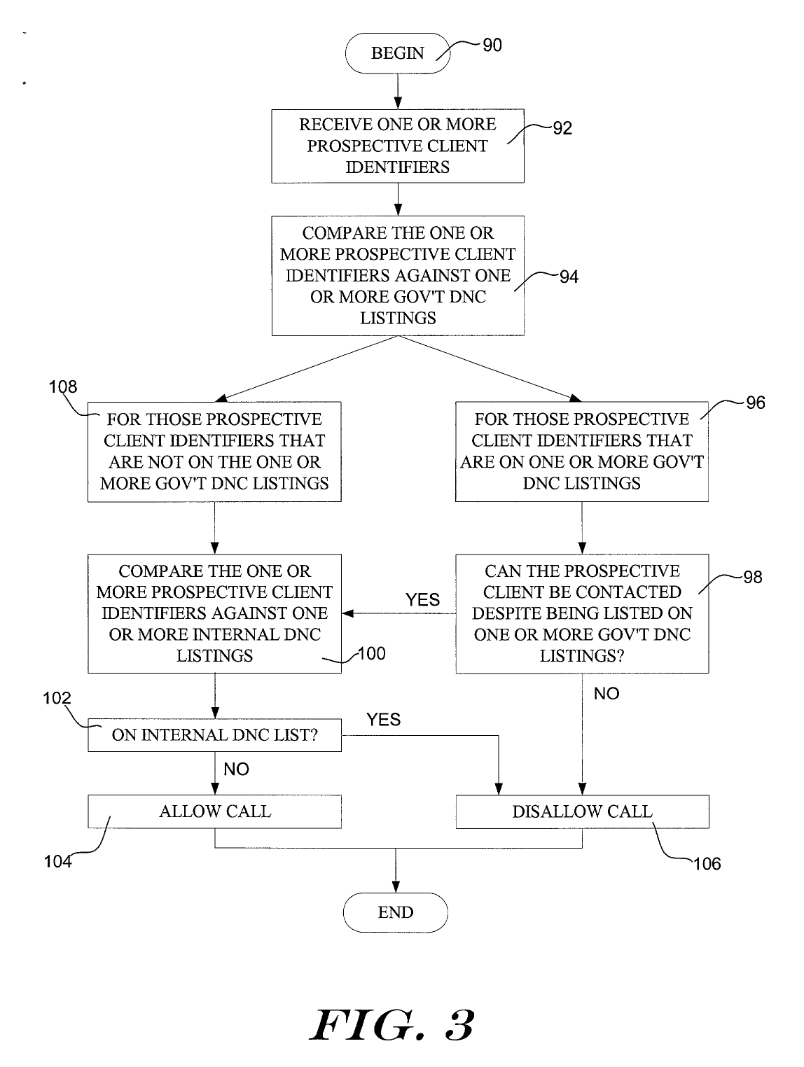

FIG. 3 is a flow diagram showing an illustrative method in accordance with the present invention. The illustrative method is entered at step 90, wherein control is passed to step 92. Step 92 gains access to one or more Do-Not-Call (DNC) listings, wherein each of the DNC listings has a number of entries that identify prospective clients that do not want to be called. Step 94 receives one or more prospective client identifiers, each corresponding to a prospective client 94. The prospective client identifiers may be provided by, for example, a representative of the organization. In some embodiments, the prospective client identifiers are manually provided, while in other embodiments, the prospective client identifiers are provided via a prospective client listing, as described above. Step 94 compares or otherwise determines which of the prospective clients, if any, have a prospective client identifier that includes a corresponding entry in at least one of the DNC listings, resulting in a number of identified DNC prospective clients.

For those prospective clients that include a corresponding entry in at least one of the DNC listings, control is passed to step 98 via decision block 96. Step 98 determines if a particular identified DNC prospective clients can be contacted by a representative of the organization, despite being listed on one or more the DNC listings. If it is determined that the particular identified DNC prospective client can be contacted, control is passed to step 100. Step 100 compares or otherwise determines if the particular identified prospective client is listed on one or more internal DNC listings. If the particular identified prospective client is not on the one or more internal DNC listings, control is passed to step 104, and the call is allowed. If the particular identified prospective client is on one or more of the internal DNC listings, control is passed to step 106, and the call is disallowed. Referring back to step 98, if it is determined that the particular identified DNC prospective client cannot be contacted, control is passed to step 106, and the call is disallowed.

Referring back to step 94, for those prospective clients that do not include a corresponding entry in at least one of the DNC listings, control is passed to step 100 via decision block 108. Step 100 compares or otherwise determines if the particular identified prospective client is listed on one or more internal DNC listings. If the particular identified prospective client is not on the one or more internal DNC listings, control is passed to step 104, and the call is allowed. If the particular identified prospective client is on one or more of the internal DNC listings, control is passed to step 106, and the call is disallowed.

The method shown in FIG. 3 is merely illustrative, and it should be recognized that, for example, the order and/or sequence of steps may be changed and still be within some embodiments of the present invention. In addition, some of the steps may be eliminated, or additional steps may be added, and still be within the present invention.

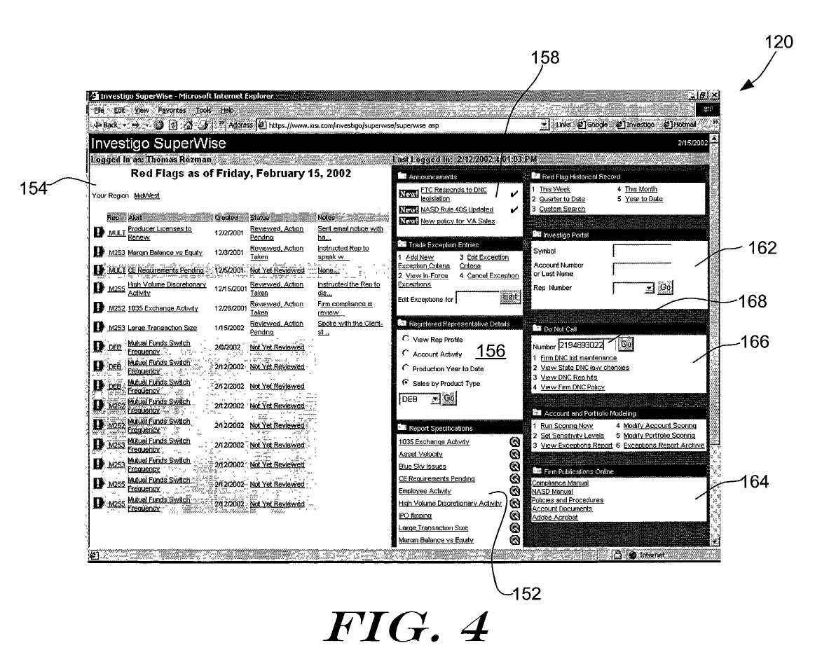

FIG. 4 is a screen shot of an illustrative window that may be displayed by the Broker/Dealer Interface and Control Block of FIG. 1. The illustrative window is generally shown at 120, and includes a number of regions. The regions include, for example, a report specification region 152, a red flags region 154, a representative details region 156, an announcements region 158, an Investigo® portal region 162 that enables efficient access to the customer database by a supervisor, a firm publications region 164, and a Do-Not-Call region 166.

The report specification region 152 identifies the reports that are currently available to the compliance supervisor or firm. Some of these reports may be defined by personnel of the firm, provided to the firm by outside vendors, or a combination thereof. In the illustrative window shown in FIG. 4, the report specification region 152 shows nine reports including an “1035 Exchange Activity” Report, an “Asset Velocity Report, a “Blue Sky Issues” report, a “CE Requirements Pending” report, an “Employee Activity” report, a “High Volume Discretionary Activity” report, an “IPO Flipping” report, a “Large Transaction Size” report, and a “Margin Balance vs. Equity” report. It should be recognized that these reports are only illustrative.

Each report preferably identifies one or more actual or potential unacceptable activity that may be performed by representatives of the firm, which may be used by a compliance supervisor to monitor and/or detect potential unacceptable activity. Each report preferably defines one or more actual or potential unacceptable activity using one or more unacceptable activity parameters. In a preferred embodiment, some or all of the unacceptable activity parameters are changeable by the supervisor or supervising group. This may give the firm added flexibility in defining and identifying unacceptable activity within the firm.

For example, the “Margin Balance vs. Equity” report may be used to detect those accounts that have an excessive margin balance relative to total equity. Illustrative parameters that may be set by the supervisor may include a margin balance percentage, and whether the representative has a discretionary agreement with the customer. Likewise, the “Employee Activity” report in the report specification region 152 of FIG. 4 may be used to detect excessive trading activity by firm employees in a particular stock. Illustrative parameters include the symbol of the particular stock, as well as a date range. The “1035 Exchange” Report may be used to detect excessive Annuity 1035 Exchange activity. Illustrative parameters for this report may include the number of 1035 transactions and a date range. The “High Volume Discretionary Activity” report may be used to detect excessive trade activity for accounts that are designated as discretionary. Illustrative parameters for this report include the number of transactions, a date range, and whether the business was solicited or unsolicited.

Once the various reports have been defined and the unacceptable activity parameters set, each report (or subset of reports) may be run against the database 30 (see FIG. 1). It is contemplated the all or some of the reports may be run against the database when, for example, prompted by a supervisor or when a representative uses a particular function such as a stock buy function. Alternatively, or in addition, some or all of the reports may be run automatically in a batch mode at some desired frequency interval including up to real or near real time. Under some circumstances, it may be desirable to run some or all of the reports in batch mode during off-peak hours, which may reduce the load on the database 30 during ordinary business hours.

When run, the unacceptable activity parameters are compared against the activities and/or data recorded in the database 30. An alert is then displayed in the red flags region 154 of FIG. 4 for each of the activities that fall within the unacceptable activity parameters of the reports. Activities that do not fall within the unacceptable activity parameters are not reported or displayed in some embodiments, thereby eliminating much of the clutter that might otherwise exist. The listing of alerts may be stored in the database 30 for later reference, if desired.

Each alert in the red flag region 154 preferably identifies selected high-level information that might be of interest to a supervisor when reviewing the alerts. In the illustrative embodiment, each alert displays the representative that is associated with the activity, a description of the alert which in the embodiment shown corresponds to the title of the report that identified the activity, the date of the alert, the current status of the alert, and any notes that have been recorded for the alert.

Some of the information provided in the alert may be in the form of a hyperlink. For example, the representative identifier (e.g. “3BR”) shown in the second to last alert of FIG. 4 may be in the form of a hyperlink, which when selected, may display a representative profile for the representative “3BR”. The representative profile may include, for example, the representative's name, address, affiliate firm, licensure information, as well as other information. Although not shown, a log of questionable activity may be maintained for each representative, and displayed in the representative profile if desired. This may help a supervisor or the like identify those representatives that are more likely to be involved in unacceptable activity. The log itself may be searched to identify, for example, all representatives that have been the subject of more than five (5) alerts in the past year.

The description of the alert may also be in the form of a hyperlink. For example, the description of the alert “Margin Balance vs. Equity” shown in the second alert may be in the form of a hyperlink, which when selected, may display the accounts of representative “3BR” that meet the unacceptable activity parameters of the “Margin Balance vs. Equity”.

From the listing of alerts, a supervisor or the like may review and perform appropriate follow up activity, as desired. The supervisor preferably records his or her follow up activity in the database in the “notes” field. The “notes” field for each alert may also be in the form of a hyperlink, as shown. In the example shown, the notes field for the alert “Margin Balance vs. Equity” is in the form of a hyperlink, which when selected, displays the notes that have been recorded, if any. For the “Margin Balance vs. Equity” alert of FIG. 4, the phrase “Instructed Rep to speak w/” is displayed in the notes field.

Initially, the status of each alert is set to “Not Yet Reviewed” as the default value. When the status of an alert is still “Not Yet Reviewed”, the alert is highlighted in a designated color (shown shaded in FIG. 4) in the red flags region 154 of FIG. 4. This allows the supervisor to immediately identify those alerts that have not yet been reviewed. After the alert is reviewed, the supervisor preferably changes the status of the alert to one of a number of other status categories. In one illustrative embodiment, the status of an alert may be changed to “Reviewed, No Action taken”, “Reviewed, Action Pending”, Reviewed, Action Taken”, and “Forwarded on for Review”. Once the status of an alert is changed from “Not Yet Reviewed”, the alert is no longer highlighted in the designated color in the red flag region 154 of FIG. 4.

In addition to the reports discussed above, FIG. 4 also provides access to information that may allow a supervisor to proactively check for various compliance issues. For example, when a supervisor clicks on a hyperlink corresponding to a representative, or selects the view rep profile button in region 156, the representative profile may be displayed. The representative profile may show the states in which the representative is licensed. The supervisor may check for trade activity that is conducted in states outside of the representatives licensed states. If desired, reports may be defined to detect these and other compliance issues. A further discussion on these and other functions of the interface shown in FIG. 4 can be found in co-pending U.S. patent application Ser. No. 09/917,447, filed Jul. 27, 2001, entitled “Methods And Systems For Providing A Measure Of Supervision Over The Activities Of Representatives Of A Business”, which is incorporated herein by reference.

The Do-Not-Call region 166 may allow a supervisor to, for example, check a particular phone number against the DNC listings or files 66 (see FIG. 2), perform firm DNC list maintenance, view state DNC law changes, view DNC representative hits, and/or view the firm's DNC policy. During use, and in one illustrative embodiment, the supervisor may enter a prospective client's phone number in dialog box 168, and then hit the “Go” button. In response, the DNC handler block 62 of FIG. 2 may return whether the prospective client can be contacted by a representative of the firm. In some embodiments, this is done by identifying if the prospective client has a corresponding entry in at least one of the DNC listings 68a, 68b, 68c, 70, 72a and 72b. If the prospective client has a corresponding entry in at least one of the DNC listings 68a, 68b, 68c, 70, 72a and 72b, the DNC handler block 62 may report that the prospective client should not be called. Conversely, if the prospective client does not have a corresponding entry in at least one of the DNC listings 68a, 68b, 68c, 70, 72a and 72b, the DNC handler block 62 may report that the prospective client can be called.

As indicated above, it is contemplated that the DNC handler block 62 may perform additional processing to determine if a prospective client can be contacted, despite having a corresponding entry in at least one of the DNC listings 68a, 68b, 68c, 70, 72a and 72b. For example, and as noted above, some of the DNC listings 68a, 68b, 68c, 70, 72a and 72b may have one or more exemptions that allow at least some of the prospective clients listed therein to be contacted by a telemarketer or other sales person.

In one illustrative embodiment, DNC handler block 62 may determine if the telemarketer or other sales person, and/or the organization represented by the telemarketer or other sales person, has an existing or prior relationship with the prospective client. This may be accomplished by, for example, gaining access to one or more databases, such as database 30a, 30b and/or 30c of FIG. 1, that identify existing and/or former clients of the telemarketer or other sales person, and/or the organization represented by the telemarketer or other sales person. In some cases, several databases may be accessed, each associated with a different business unit or the like of the organization.

The DNC handler block 62 may then compare the identified prospective clients with those clients that have an existing or prior relationship with the telemarketer or other sales person, and/or the organization represented by the telemarketer or other sales person. If an existing or prior relationship exists, the DNC handler block 62 may report that the prospective clients may be contacted, despite have a corresponding entry in at least one of the DNC listings 68a, 68b, 68c, 70, 72a and 72b.

As noted above, what constitutes a “prior or existing relationship” can vary widely depending on the state. As such, and in some embodiments, the DNC handler block 62 may mine the one or more databases, such as database 30a, 30b and/or 30c of FIG. 1, to determine values that can be used to help determine the nature or status of the prior or existing relationship with the organization. For example, the DNC handler block 62 may mine the one or more databases 30a, 30b and/or 30c to determine the length of time since the client transacted business with the organization, whether the client has dealt with the organization itself, or a sub- or related-organization, the types of transactions or contact made, whether and what type of accounts the client has or had with the organization, whether the client has an outstanding balance on any accounts within the organization, etc.

In some embodiments, the DNC handler block 62 may also reference one or more parameters that relate to selected exemptions, such as the prior existing relationship exemption. Each of the parameters may have one or more values that reflect or define whether an exemption is satisfied. For example, to help determine whether a valid prior or existing relationship exists, the parameters may include one or more values that define that if a client transacted business with the organization within the past year, a prior or existing relationship exists. The DNC handler block 62 may apply the parameter values to the values mined from the one or more databases to determine, if for a particular client, a prior or existing relationship exists. Because the definition of when a prior or existing relationship exists may differ depending on the state, different parameter values may be set for each of the state DNC listings 68a, 68b and 68c, as desired.

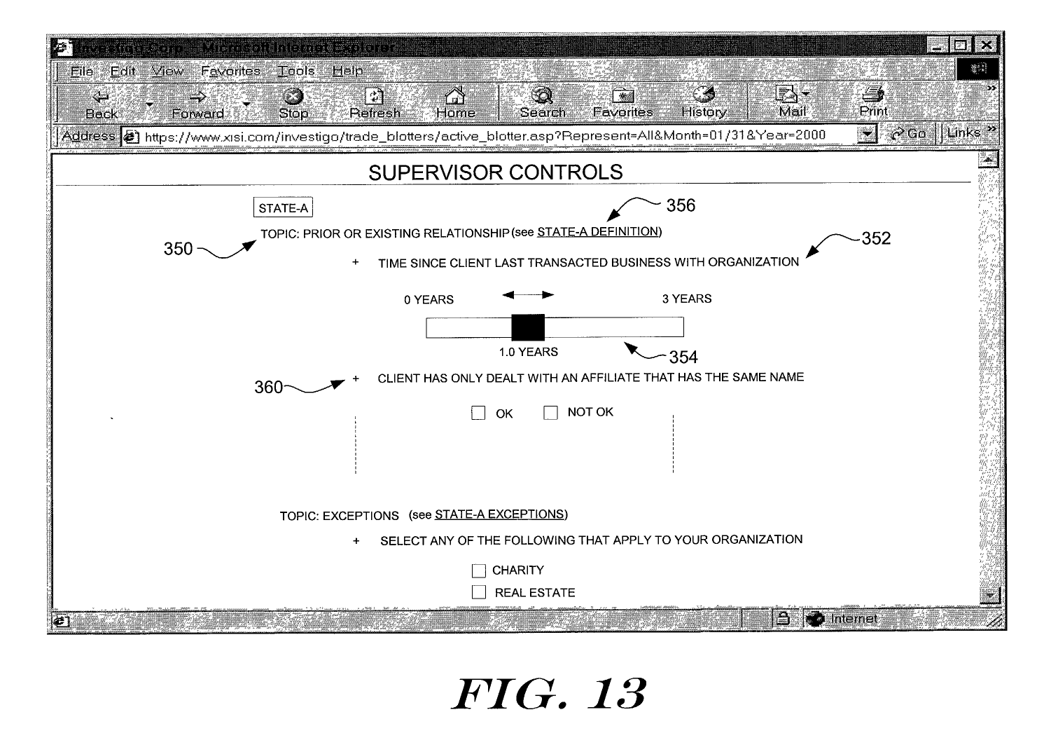

In some embodiments, some or all of the parameter values may be set by a compliance authority or the like in the organization. In the illustrative embodiment, this may be accomplished by using the “Firm DNC list maintenance” hyperlink in the Do-Not-Call region 166 of FIG. 4. For example, the “Firm DNC list maintenance” hyperlink may direct the supervisor to a supervisor control window, such as shown in FIG. 13, which may allow the supervisor to set one or more parameter values that help define which DNC prospective clients can be contacted. As noted above, determining when an exemption is satisfied can depend on a number of factors including, for example, the business that the organization is in, the risk tolerance of the organization, and well as many others factors.

The “View State DNC law changes” hyperlink in the Do-Not-Call region 166 of FIG. 4 may provide the supervisor with access to, for example, each state's DNC laws, and in some cases, a summary of any recent changes to state DNC laws. Access to the state's DNC laws may be helpful in a variety of circumstances. For example, access to the state's DNC laws may be useful when the supervisor is setting the parameter values used by the DNC handler block 62 to determine when, for example, a prior or existing relationship exists in a particular state.

The “View DNC Rep Hits” hyperlink in the Do-Not-Call region 166 of FIG. 4 may provide the supervisor with access to information related to, for example, which prospective clients submitted by a representative were identified by the DNC handler block 62 as not to be called, and in some cases, a date stamp. This may be useful in recording and/or identifying if any of the representatives of the organization are calling prospective clients that should not be called. The “View Firm DNC Policy” hyperlink may display the firms DNC policy.

While FIG. 4 may show some illustrative DNC functions in the context of co-pending U.S. patent application Ser. No. 09/917,447, filed Jul. 27, 2001, entitled “Methods And Systems For Providing A Measure Of Supervision Over The Activities Of Representatives Of A Business”, it is contemplated that some and/or all of these illustrative DNC functions may be provided in the context of, for example, co-pending U.S. patent application Ser. No. 09/917,120, filed Jul. 27, 2001, entitled “Methods and Systems for Assisting Financial Services Firms and Their Representatives”, and/or co-pending U.S. patent application Ser. No. 09/916,951, filed Jul. 27, 2001, entitled “Methods and Systems for Monitoring the Efficacy of a Marketing Project”, if desired. In addition, some and/or all of the illustrative DNC functions, as well as others, may be adapted to other applications, including traditional direct telemarketing applications as well as other applications.

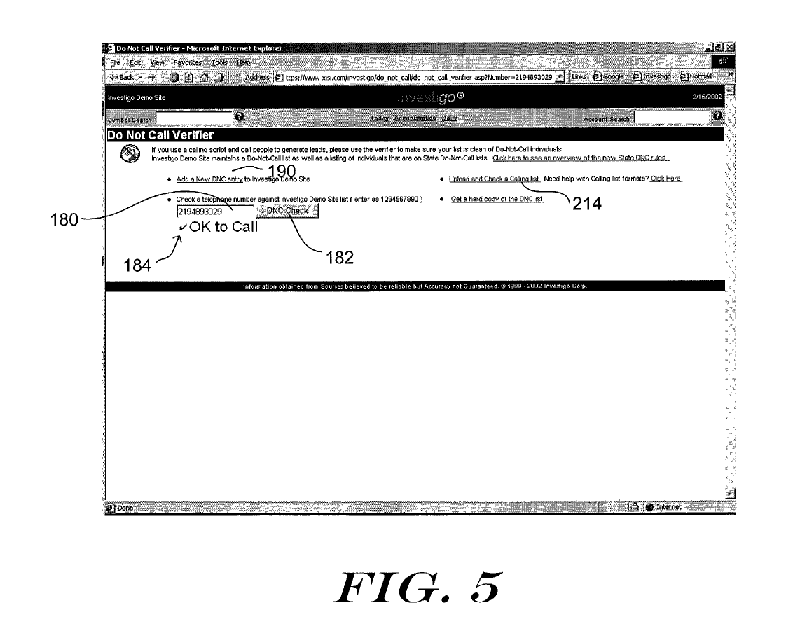

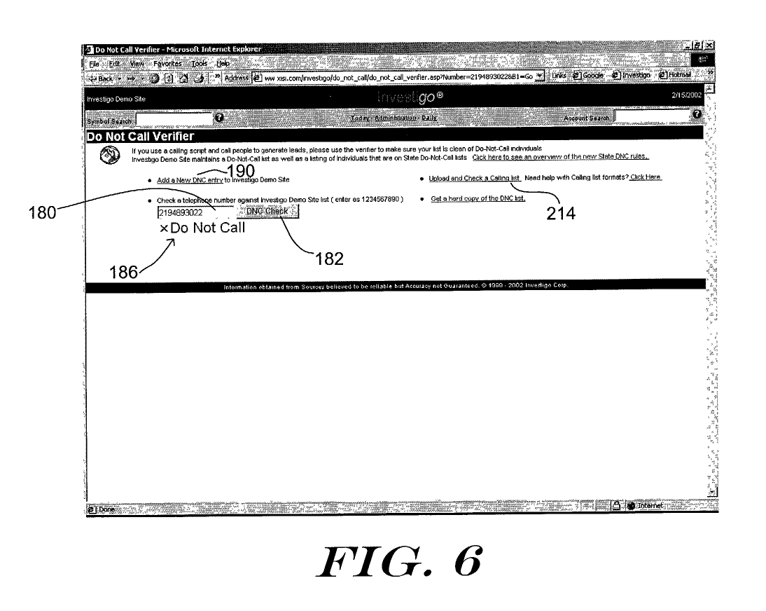

FIG. 5 is a screen shot of an illustrative window that may be displayed after determining that a prospective client's phone number can be called. In the illustrative window, a representative or the like has already entered a prospective client's phone number in dialog box 180, and hit the “DNC Check” button 182. The DNC handler block 62 has returned the message “OK to Call” as shown at 184. FIG. 6 is a screen shot of an illustrative window that may be displayed after determining that a prospective client's phone number should not be called. In the illustrative window, a representative or the like has already entered a prospective client's phone number in dialog box 180, and hit the “DNC Check” button 182. The DNC handler block 62 has returned the message “Do Not Call” as shown at 186.

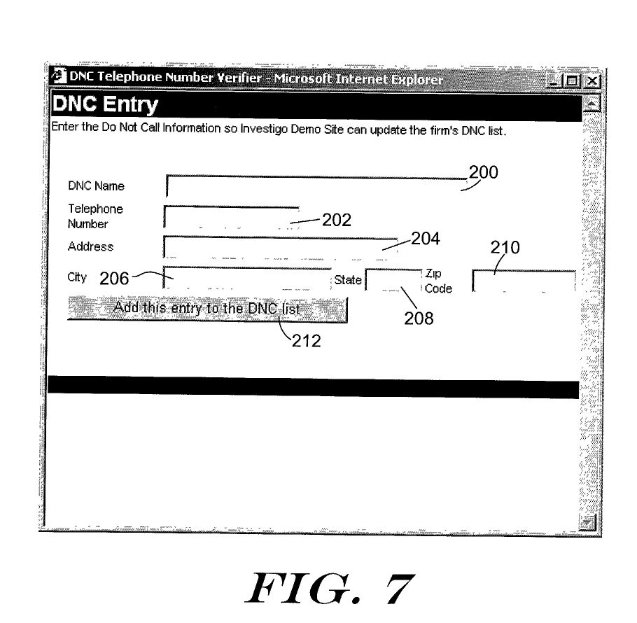

In some cases, the representative may wish to add the prospective client's phone number to a DNC listing, such as an internal DNC listing. For example, if the prospective client's phone number is indicated as “OK to Call” as shown in FIG. 5, the representative may make the call. However, the prospective client may request to be placed on the firm's DNC listing. In the illustrative windows of FIGS. 5-6, this may be easily accomplished by clicking on the “Add a New DNC entry” hyperlink 190. In some embodiments, the “Add a New DNC entry” hyperlink 190 may produce a window similar that shown in FIG. 7. The illustrative window of FIG. 7 includes a number of fields including a DNC name field 200, a telephone number field 202, an address field 204 a city field 206, a state field 208 and a zip code field 210. In some cases, the telephone number field 202 and other fields may be automatically filled in by the system if the information is available. The representative may fill in the remaining fields, if desired, and hit the “Add this entry to the DNC list” button 212. The system may then add the entry to a DNC listing, such as an internal DNC listing 72a and/or 72b of FIG. 2.

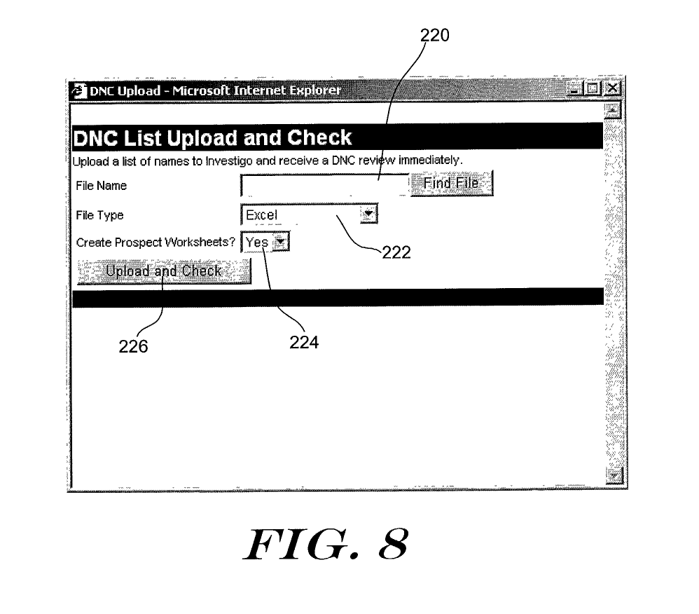

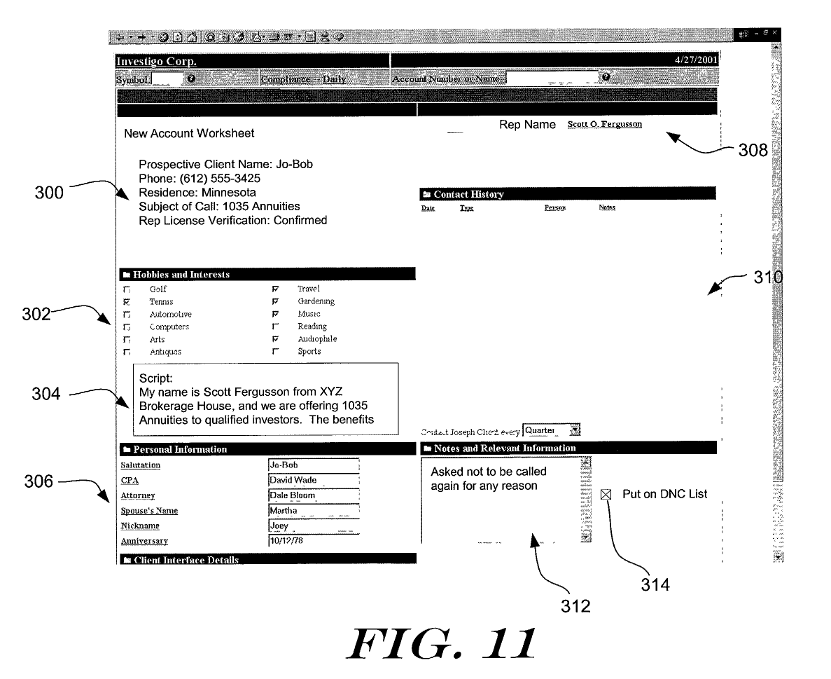

As indicated above with respect to FIG. 2, the illustrative DNC handler block 62 may receive a name, phone number or other identifier of one or more prospective clients via a prospective client list 78. In some embodiments, the prospective client list 78 is a list purchased or otherwise obtained from one or more list sources, such as direct marketing companies or the like. The “Upload and Check a Calling List” hyperlink 214 of FIGS. 5-6 can be used to import prospective client lists 78. For example, when a representative or the like clicks on the “Upload and Check a Calling List”, a window may be provided that accepts a file name, a file type and or other information related to the prospective client list. One such window is shown in FIG. 8. FIG. 8 includes a file name field 220 and a file type field 222. The representative may enter the file name and file type of the prospective client list, and click on the “Upload and Check” button 226. The system may then upload the prospective client file, and in some cases, check the prospective clients listed in the prospective client file against the DNC listings or files 66. The “Create Prospect Worksheets” dialog box can be used to automatically create new account worksheets for those prospective clients that the DNC handler block 62 determines can be called by the representative. One illustrative new account worksheet is shown and described below with respect to FIG. 11.

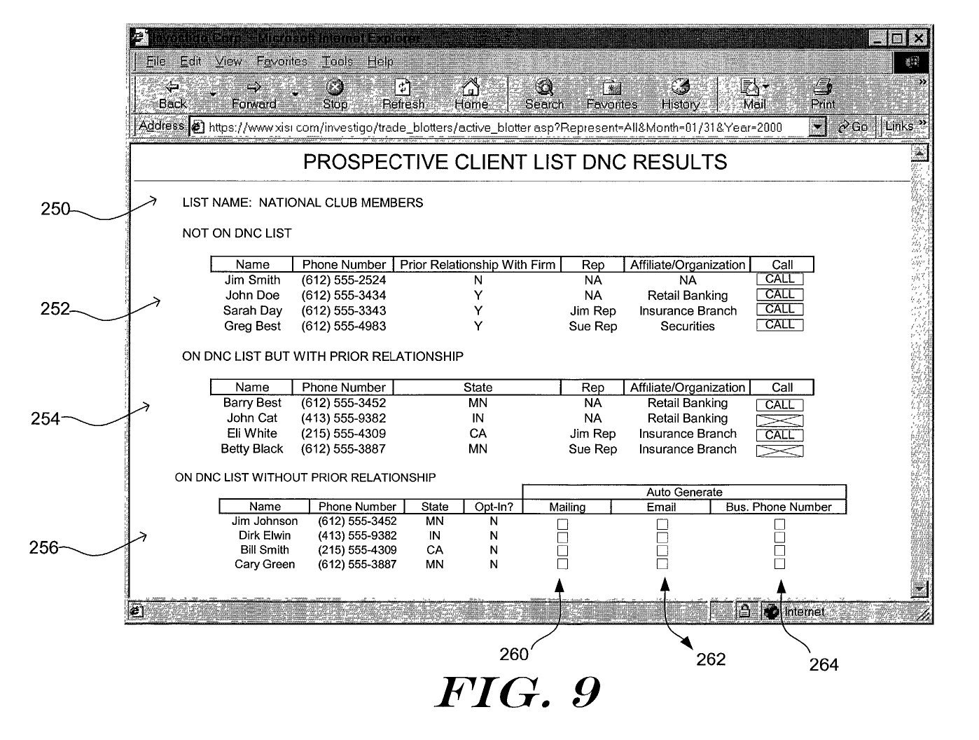

FIG. 9 is a screen shot of an illustrative window that may be displayed after a list of prospective clients has been submitted to the system and checked against one or more DNC listings. The illustrative window identifies the prospective client list at 250, and includes a “Free to Call” region 252, a “On DNC List But With Prior Or Existing Relationship” region 254, and a “On DNC List Without Prior Or Existing Relationship” region 256.

The “Free to Call” region 252 identifies the names of those prospective clients that are not included on any DNC file or listing 66. Even for these prospective clients, the system may determine if a prior relationship exists. In some embodiments, the DNC handler block 62 may mine the one or more databases, such as database 30a, 30b and/or 30c of FIG. 1, to determine if any of the prospective clients listed in the “Free to Call” region 252 have, for example, been previous or are current clients of the organization.

In the illustrative embodiment, the DNC handler block 62 reports if a prior or existing relationship exists, and if so, which representative handled or handles the relationship, and the organization or sub- or related-organization that handled or handles the relationship. By knowing the nature of the relationship, the representative may decide not to call the prospective client, may contact the prior representative to explore cross-selling opportunities, or perform some other action. In some cases, more or less information may be displayed in the “Free to Call” region 252 as desired.

In the illustrative embodiment, the “On DNC List But With Prior or Existing Relationship” region 254 identifies the names of those prospective clients that are on a DNC file or listing 66, but have a prior or existing relationship with the organization. In the illustrative embodiment, the DNC handler block 62 reports which state DNC list the prospective clients are listed, the representative within the organization that handled or handles the prior or existing relationship, and the organization or sub- or related organization or affiliate that handled or handles the prior relationship. A call column is also provided, which indicates whether the representative can call the prospective client or not.

As can be seen, and in the illustrative embodiment, the DNC handler block 62 reports that some of the prospective clients listed in the “On DNC List But With Prior Or Existing Relationship” region 254 can be called, while others cannot. In the example shown, the DNC handler block 62 indicates that Barry Best can be contacted. Barry Best is listed on the Minnesota DNC listing, and had a prior or existing relationship with the retail banking division of the financial services organization of the calling representative. In contrast, the DNC handler block 62 reports that John Cat cannot be contacted. John Cat is listed on the Indiana DNC listing, and also had a prior or existing relationship with the retail banking division of the financial services organization of the calling representative. In the illustrative embodiment, these different outcomes are caused by the different definitions of what a “prior existing relationship” is in Minnesota versus Indiana. In this example, the definition of a “prior or existing relationship” is narrower in Indiana than in Minnesota.

The DNC handler block 62 also indicates that Eli White can be contacted. Eli White is listed on the California DNC listing, and had a prior or existing relationship with the Insurance Branch of the financial services organization of the calling representative. In contrast, Betty Black cannot be contacted. Betty Black is listed on the Minnesota DNC listing, and also had a prior or existing relationship with the Insurance Branch of the financial services organization of the calling representative. In the illustrative embodiment, these different outcomes are again caused by the different definitions of what a “prior or existing relationship” is in Minnesota versus California. In this example, California defines a “prior or existing relationship” if the prospective client has or had a prior relationship with an affiliate of the financial services organization of the calling representative, so long as the affiliate has a common name with the financial services organization of the calling representative. In contrast, Minnesota may not define a “prior or existing relationship” when the prospective client has or had a prior relationship with an affiliate of the financial services organization of the calling representative, even if the affiliate and the financial services organization of the calling representative have a common name. These examples are only meant to illustrate some differences that might exist between state DNC laws, and are not meant to necessarily reflect the actual laws of the named states. In some cases, more or less information may be displayed in the “On DNC List But With Prior or Existing Relationship” region 254, as desired.

The “On DNC List Without Prior Or Existing Relationship” region 256 identifies the names of those prospective clients that are included on a DNC file or listing 66 and have no valid prior or existing relationship with the organization. Note that John Cat and Betty Black, which are listed in the “On DNC List But With Prior Existing Relationship” region 254, may also be listed in the “On DNC List Without Prior Or Existing Relationship” region 256 because their prior or existing relationship with the organization did not comply with the appropriate DNC laws.

In some cases, the various DNC laws only prevent an organization from contacting prospective clients that are listed on a DNC lists and have no valid prior or existing relationship with the organization at their home via the phone. As such, and in some embodiments, the system may determine additional contact information for some or all of the identified prospective clients other than the prospective client's home phone number. In some cases, the limited information known about a prospective client can be provided to one or more databases that return additional contact information. The one or more databases may include, for example, a phone company database, or other database, as desired. For example, the phone number of a prospective client can be extracted from a DNC listing, and provided to a reverse phone number lookup database that returns the home address of the prospective client. Other contact information may also be obtained in a similar manner including, for example, the work phone number, e-mail address or other contact information of the prospective client. The system may provide the other contact information to the representative, as desired. In some embodiments, the system may help generate a mailing or e-mail, such as with a mail merge function or the like, that can then be sent to the prospective client.

In the illustrative embodiment shown in FIG. 9, the names of those prospective clients that are included on a DNC file or listing 66 and have no valid prior or existing relationship with the organization are listed. The DNC handler block 62 also reports which state DNC list each of the prospective clients are listed, and whether the prospective clients have opted-in to receiving phone calls related to the product the representative is attempting sell. In some cases, more or less information may be displayed in the “On DNC List Without Prior Or Existing Relationship” region 256, as desired.

One or more “Auto-Generate” columns may also be provided. For example, a mailing column 260, an E-mail column 262 and a Business Phone Number column 264 may be provided, each having a check box or the like that can be selected by a representative. When the representative selects a check box in the mailing column 260, for example, the system may help generate a mailing that can be sent to the prospective client. In some cases, the system may automatically obtain the prospective clients mailing address from a database, and using a mail merge function (such as in Microsoft Word), generate custom letters and/or other marketing materials that can be sent to the prospective clients. A label or envelope having the prospective clients name and address may also be automatically generated, if desired.

When the representative selects a check box in the E-mail column 262, the system may help generate an E-Mail that can be electronically delivered to the prospective client. The system may, for example, automatically obtain the prospective clients e-mail address from a database, and using a mail merge function or the like, generate custom e-mail messages and/or other marketing materials for the prospective clients. The system may also automatically send the e-mail message to the prospective clients, if desired.

When the representative selects a check box in the business phone number column 264, the system may, for example, automatically obtain the prospective clients business phone number from a database, and provide the business phone number to the representative. The representative may then contact the prospective client at the prospective client's business phone number.

In some embodiments, the system may identify which additional contact information is available for each prospective client before displaying the window shown in FIG. 9. When so provided, only those check boxes that can be actually implemented by the system may be active. For example, if the system cannot identify the E-mail address or business phone number of Jim Johnson, but can identify the mailing address, the mailing address check box may be active and the E-mail check box and Business Phone Number check box may be inactive.

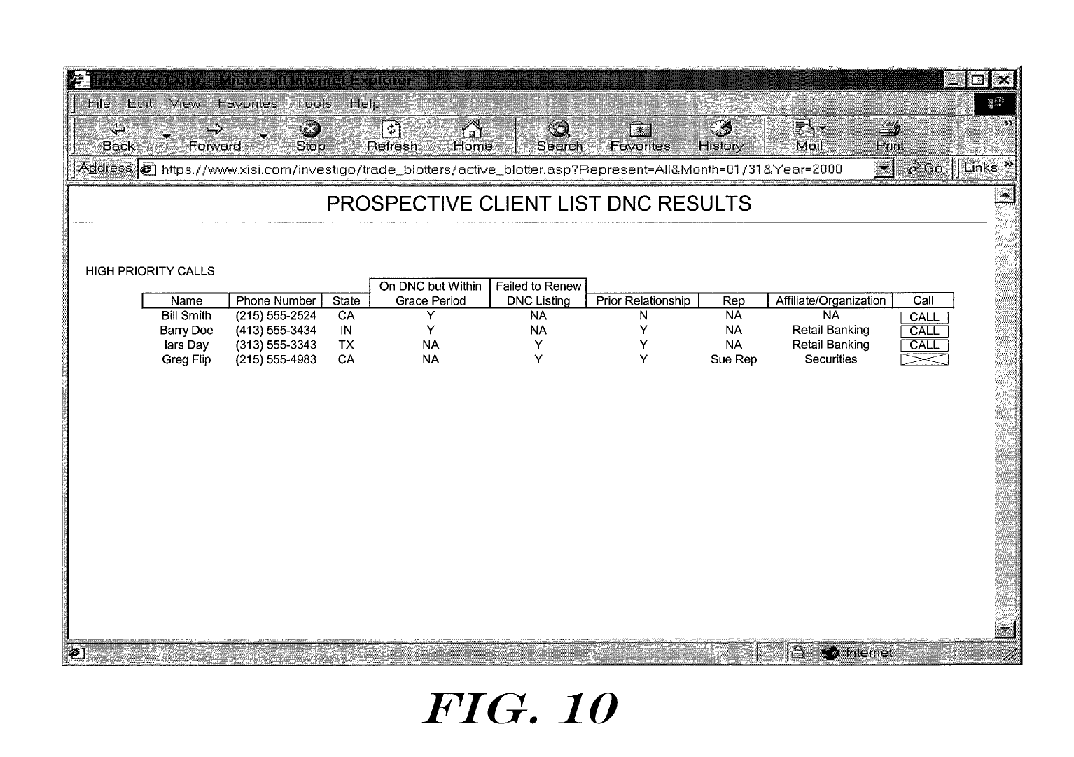

FIG. 10 is a screen shot of an illustrative window that may be displayed to identify high priority prospective clients. As indicated above, DNC listings may be updated and released on a regular basis, such as monthly or quarterly. An updated DNC listing may include new names that correspond to prospective clients that have recently subscribed to the DNC listing. Likewise, an updated DNC listing may be missing names that were present on a previous DNC listing. The missing names may correspond to prospective clients that have failed to re-subscribe to the DNC listing. In many instances, the updated DNC listing is made available before it becomes effective. The grace period between when an updated DNC listing is made available and when it becomes effective is often used to give organizations time to distribute and react to the updated DNC listing.

It is contemplated that the system of the present invention may compare a previous DNC listing to an updated DNC listing, and identify those names that have just been added to the updated DNC listing. This may be done after the updated DNC listing is released but before the grace period expires. Once identified, those prospective clients that were newly added to the updated DNC listing can be contacted, at least until the grace period expires. In some cases, a high priority can be assigned to at least some of the prospective clients for contact by the organization before the grace period expires.

In another illustrative embodiment, the system of the present invention may compare the previous DNC listing with the updated DNC listing to identify those prospective clients that are missing from the updated DNC listing. In some cases, a high priority can be assigned to at least some of the identified prospective clients that are missing from the updated DNC listing for contact by the organization.

FIG. 10 lists four prospective clients. The first prospective client, Bill Smith, is shown to have just been added to the updated California DNC listing, and that no prior or existing relationship exists with the organization of the calling representative. The second prospective client, Barry Doe, is shown to have just been added to the updated Indiana DNC listing, and that a prior relationship exists with the retail banking division of the organization of the calling representative. As of the date of the report, it shows that both Bill Smith and Barry Doe can be called because the grace period of the respective state's DNC laws has not yet expired.

The third prospective client, Lars Day, is shown to have failed to re-subscribe to the Texas DNC listing, and that a prior relationship exists with the retail banking division of the organization of the calling representative. Finally, the fourth prospective client, Greg Flip, is shown to have failed to re-subscribe to the California DNC listing, and that a prior relationship exists with the Securities division of the organization of the calling representative. The prior representative's name in the Securities division with the prior relationship with the prospective client is also shown. By knowing the prior representative's name, the representative may decide not to call the prospective client, may contact the prior representative to explore cross-selling opportunities, or perform some other action, as desired. In some cases, more or less information may be displayed in the illustrative window of FIG. 10.

Because the organization may not be able to contact those prospective clients that have just been added to the updated DNC listing after the grace period expires, particularly when no valid prior or existing relationship exists, a high priority may be given to call these prospective clients. Likewise, because the organization may not be able to contact those prospective clients that failed to re-subscribe to the DNC listing, but may re-subscribe soon, a high priority may also be given to call these prospective clients, if desired.

FIG. 11 is a screen shot of an illustrative New Account Worksheet that may be displayed when a representative, telemarketer or other sales person is going to make a call to a prospective client. As noted above with respect to FIG. 8, and in some embodiments, the New Account Worksheet may be automatically generated for those prospective clients that the DNC handler block 62 indicates can be called. The illustrative New Account Worksheet shown in FIG. 11 includes a Prospective Client Identity region 300, a Hobbies and Interests region 302, a Script region 304, a Personal Information region 306, a Rep Info region 308, a Contact History region 310, and a Notes region 312.

The prospective client identity region 300 may include information that identifies the prospective client. This information may include, for example, the prospective client's name, phone number, state of residence, etc. The prospective client identity region 300 may also include the subject or purpose of the call, and whether the representative making the call (identified in the Rep Name region 308) has a valid license to sell the particular product in the state that the prospective client resides. More or less information may be displayed in the prospective client identity region 300, as desired.

The Hobbies and Interests region 302 may include a number of check boxes or other data entry mechanisms for recording the hobbies and interests of the prospective client. The representative may solicit the hobbies and interests of the prospective client during the phone call.

The Script region 304 may include the script that the representative intends to use during the call to the prospective client. In some cases, the script is a script that was previously approved by a compliance supervisor of the organization, and is used by all representatives within the organization when calling prospective clients regarding a particular product or service.

The Personal information region 306 may include a number of dialog boxes or other data entry mechanisms for recording personal information relative to the prospective client. The representative may solicit the personal information from the prospective client during the phone call.

The Rep Info region 308 identifies the representative of the organization that is making the call. The contact history region 310 identifies the previous contact history between the prospective client and the organization. In the example shown, no previous contact was made between the prospective client and the organization. The notes region 312 may include a dialog box or other data entry mechanisms that allows the representative to record notes or other relevant data regarding the client and/or the call. Once the notes have been submitted, a summary of the notes is included in the contact history region 310.

In the illustrative embodiment shown in FIG. 11, the representative made a call to a prospective client named Jo-Bob. The representative read the script from the script region 304, and recorded the prospective clients interests in the Hobbies and Interests region 302, and the personal information in personal information region 306, as shown. However, during the call, the prospective client indicated to the representative that he did not want to be contacted again, and that he wanted to be put on the organizations internal DNC list. The representative added a note to the notes region 312 that indicates that the prospective client did not want to be called again for any reason. The representative also selected the “Put on DNC list” check box 314. The “Put on DNC list” check box 314 causes the system to put the prospective client identified in the prospective client identity region 300 on the internal DNC list. In some embodiments, the prospective client is added to the internal DNC list in real or near real time.

Some DNC laws require that select information must be recorded for all or some calls made, and saved for a period of time in case of an audit or other investigation. In one illustrative embodiment, the system may help the representative record and save the required information. For example, when the “Put on DNC list” check box 314 is selected, the system may store the notes, an identification of the representative or other sales person making the call, the script used, the date of contact, and/or any other relevant information, as desired. In some cases, the information is stored for at least the time period prescribed by the appropriate DNC laws.

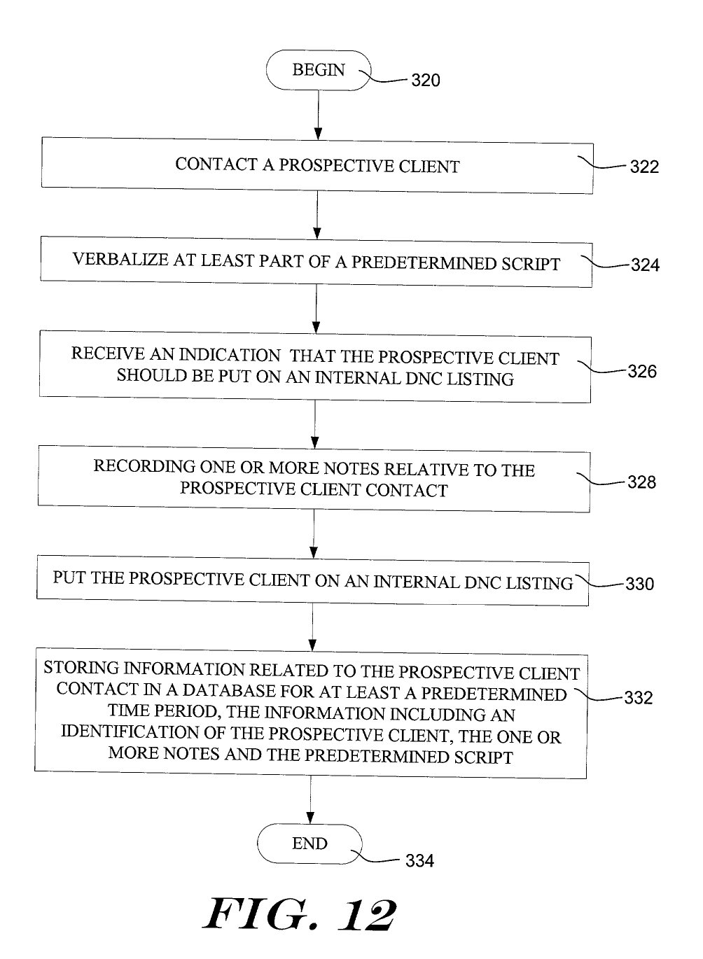

FIG. 12 is a flow diagram showing an illustrative method for contacting prospective clients. The method is entered at step 320, and control is passed to step 322. In step 322, a prospective client is contacted. In step 324, at least part of a predetermined script is verbalized to the prospective client. In step 326, an indication that the prospective client should be put on an internal DNC listing is received. Step 328 records one or more notes relative to the prospective client contact. Step 330 puts the prospective client on an internal DNC listing. Step 332 stores information related to the prospective client contact in a database for at least a predetermined time period. The information may include, for example, an identification of the prospective client, the one or more notes and/or the predetermined script, as desired. The method is then exited at step 334. This method is only meant to be illustrative, and that many variations are contemplated, including removing certain steps or adding intervening steps as desired.

FIG. 13 is a screen shot of an illustrative supervisor controls window that may be used to set one or more parameter values to help define which DNC prospective clients can be contacted by representatives of an organization. As noted above, in some embodiments, the system may reference one or more parameters that relate to, for example, selected exemptions of DNC listings, such as the prior or existing relationship exemption. In the illustrative embodiment, each of the parameters may have one or more values that reflect or define whether an exemption is satisfied. For example, to help determine whether a valid prior or existing relationship exists, the parameters may include one or more values that denote if a client transacted business with the organization within the past year, a prior or existing relationship exists.

As indicated above, the system may apply the parameter values to the values mined from the one or more databases to determine, if for a particular client, a prior or existing relationship exists. Because the definition of when a prior or existing relationship exists may differ depending on the state, different parameter values may be set for each of the state DNC listings, as desired.

In some embodiments, the parameter values may be set by a compliance authority or the like of an organization. When so provided, each organization using the system of the present invention may separately define when an exemption is satisfied. Determining when an exemption is satisfied can depend on a number of factors including, for example, the business that the organization is in, the risk tolerance of the organization, and well as many others.

The illustrative supervisor controls window of FIG. 13 allows a compliance supervisor to set selected parameter values for each state or groups of states, as desired. For example, several parameters that can be set by the compliance supervisor are illustrated under a number of topic sections for a “State-A”. The first topic section 350 is entitled “Prior Or Existing Relationship”, and includes several parameters that may help define when a prior or existing relationship exists in State-A. The first illustrative parameter 352 under the first topic section 350 relates to the time since the prospective client last transacted business with the organization. A slider bar 354 is provided, which allows the compliance supervisor to easily set the corresponding parameter value. In this example, the supervisor may believe that a prior or existing relationship exists in State-A if the prospective client conducted business with the organization within the last year. A hyperlink 356 may be provided to State-A's definition of a prior or existing relationship for reference by the compliance supervisor.

The second illustrative parameter 360 under the first topic 350 relates to whether a prospective client has dealt only with an affiliate that has the same name as the organization that is making the call. Two selection buttons are provided, which allow the compliance supervisor to easily set the corresponding parameter value. In this example, the compliance supervisor may believe that it is alright to contact a prospective client in State-A if the prospective client has dealt only with an affiliate that has the same name as the organization that is making the call. However, the compliance supervisor of another organization that is more risk adverse, may believe that it is not alright to contact a prospective client in State-A if the prospective client has dealt only with an affiliate that has the same name as the organization that is making the call. Once these parameters are set, the DNC Handler Block 62 may use the parameters when processing requests by representatives of the organization.

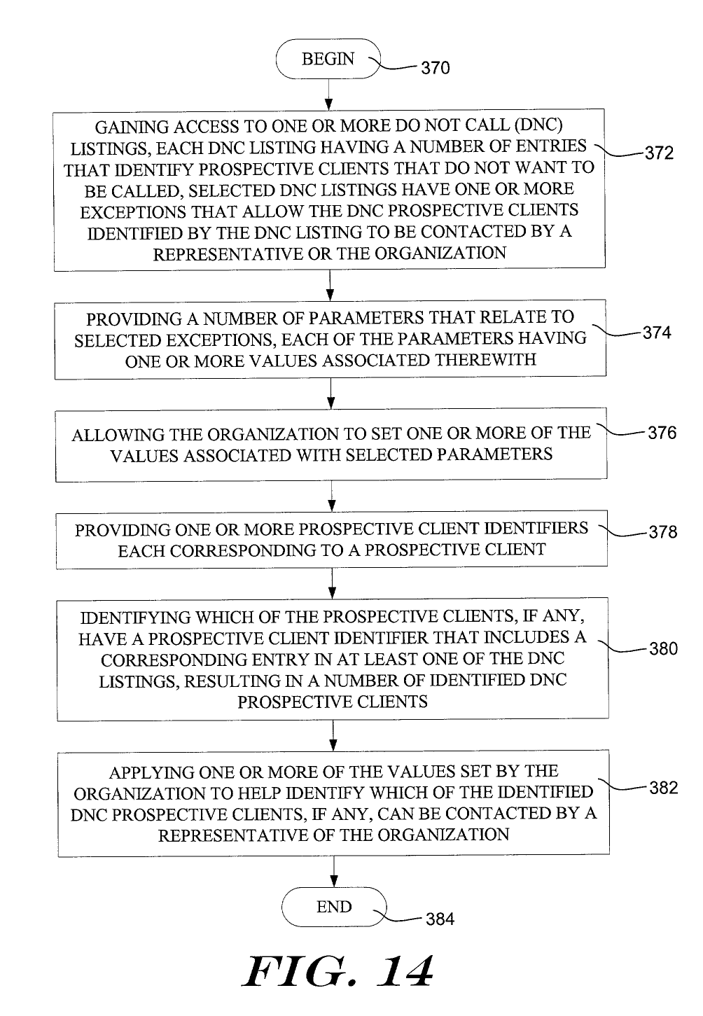

FIG. 14 is a flow diagram showing an illustrative method for identifying which DNC prospective clients can be contacted by a representative of an organization. The method is entered at step 370, and control is passed to step 372. Step 372 gains access to one or more do not call (DNC) listings. Each DNC listing may have a number of entries that identify prospective clients that do not want to be called. Selected DNC listings may have one or more exceptions that allow the DNC prospective clients identified by the DNC listing to be contacted by a representative of the organization. Step 374 provides a number of parameters that relate to selected exceptions, where each of the parameters have one or more values associated therewith. Step 376 allows the organization to set one or more of the values associated with selected parameters. Step 378 provides one or more prospective client identifiers such as a phone number, each corresponding to a prospective client. Step 380 identifies which of the prospective clients, if any, have a prospective client identifier that includes a corresponding entry in at least one of the DNC listings, resulting in a number of identified DNC prospective clients. Step 382 applies one or more of the values set by the organization to help identify which of the identified DNC prospective clients, if any, can be contacted by a representative of the organization. The method is exited at step 384. Many variations are contemplated, including removing certain steps and/or adding intervening steps as desired.

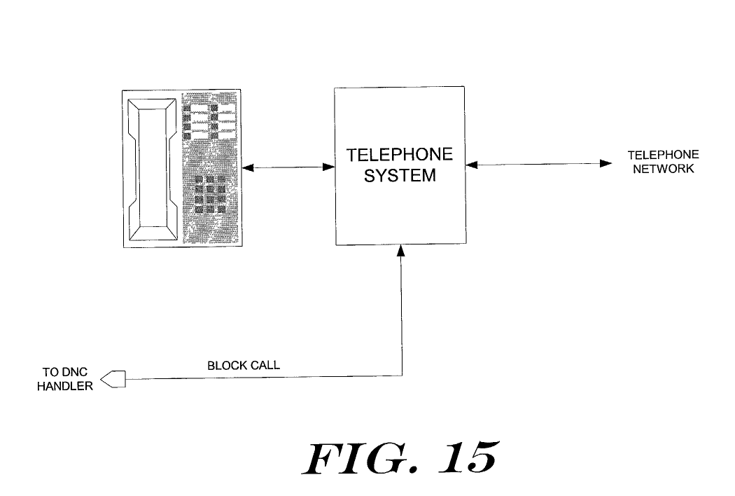

FIG. 15 is a block diagram showing an illustrative embodiment that blocks phone calls to prospective clients that should not be contacted. As detailed above, the DNC handler block 62 may determine if a particular prospective client can be contacted. It is contemplated that the DNC handler block 62 may be part of, or may interface with, a telephone or other telecommunications system. When so provided, the DNC handler block 62 may block outgoing calls that are directed to those prospective clients that the DNC Handler Block 62 determined should not be called. An over-ride feature may be provided, if desired, to allow representatives to over-ride this feature and contact the prospective client. However, even if an over-ride feature is provided, accidental calls to prospective clients that should not be contacted may be reduced or prevented.

Having thus described illustrative embodiments of the present invention, those of skill in the art will readily appreciate that the teachings found herein may be applied to yet other embodiments within the scope of the claims hereto attached.

What is claimed is:

1. A method for determining if a prospective client should be contacted by a representative of an organization, the method comprising the steps of:
gaining access to one or more Do Not Call (DNC) listings, each DNC listing having a number of entries that identify prospective clients that do not want to be called;
providing one or more prospective client identifiers each corresponding to a prospective client;
identifying which of the prospective clients, if any, have a prospective client identifier that includes a corresponding entry in at least one of the DNC listings, resulting in a number of identified DNC prospective clients; and
determining which of the DNC prospective clients, if any, can be contacted by a representative of the organization.

2. A method according to claim 1 wherein selected DNC listing have one or more exemptions that allow the DNC prospective clients to be contacted by a representative of the organization.

3. A method according to claim 2 wherein one of the exemptions include an existing and/or prior relationship between the identified DNC prospective client and the organization.

4. A method according to claim 3 wherein the determining step determines which of the identified DNC prospective clients, if any, have an existing and/or prior relationship with the organization.

5. A method according to claim 4 wherein said determining step further comprises the steps of:
gaining access to one or more databases that identify clients that have an existing and/or prior relationship with the organization; and
comparing the identified DNC prospective clients with the one or more databases.

6. A method according to claim 5 wherein the organization has one or more sub- or related-organizations, and the one or more databases identify which of the sub- or related-organizations has the existing and/or prior relationship with the identified DNC prospective client.

7. A method according to claim 6 further comprises the step of identifying a representative of the organization that has the existing and/or prior relationship with the identified DNC prospective client.

8. A method according to claim 2 wherein one of the one or more exemptions include a type of organization.

9. A method according to claim 8 wherein the type of organization includes a charity.

10. A method according to claim 8 wherein the type of organization includes a real estate organization.

11. A method according to claim 8 wherein the type of organization includes a financial services organization.

12. A method according to claim 1 further comprising the step of determining if the representative is authorized to contact the prospective client.

13. A method according to claim 12 further comprising determining a geographic region that the prospective client is located, and determining if the representative is licensed in that geographic region.

14. A method according to claim 12 wherein the representative initiates contact with the prospective client to sell a product, the method further comprising the step of:
determining if the representative is authorized to sell the product to the prospective client.

15. A method according to claim 1 wherein the contact between the representative and the prospective client is a phone call to the home of the prospective client, the method further comprising the steps of:
determining contact information for selected DNC prospective clients, wherein the contact information is information other than the DNC prospective client's home phone number; and
contacting the DNC prospective client using the contact information.

16. A method according to claim 15 wherein the other contact information includes a business phone number of the DNC prospective client, the contacting step includes contacting the DNC prospective client at work via a phone call to the business phone number.

17. A method according to claim 15 wherein the other contact information includes a mailing address of the DNC prospective client, the contacting step includes contacting the DNC prospective client via a mailing to the mailing address.

18. A method according to claim 17 wherein the selected content of the mailing is automatically generated using a mail merge function.

19. A method according to claim 15 wherein the other contact information includes an e-mail address of the DNC prospective client, the contacting step includes contacting the DNC prospective client via an e-mail to the e-mail address.

20. A method according to claim 19 wherein selected content of the e-mail is automatically generated using a mail merge function.

21. A method for contacting a prospective client by an organization, the method comprising the steps of:
contacting the prospective client;
verbalizing at least part of a predetermined script;
receiving an indication that the prospective client wants to be placed on a DNC listing;
recording one or more notes relative to the prospective client contact;
adding the prospective client to a DNC listing; and
storing information related to the prospective client contact in a database for at least a predetermined time period, the information including an identification of the prospective client, the one or more notes and the predetermined script.

22. A method according to claim 21 wherein the prospective client is contacted by a representative of the organization, the method further comprising the step of storing an identification of the particular representative that contacted the prospective client.

23. A method according to claim 21 further comprising the step of displaying to the representative a new account worksheet on a display, wherein the new account worksheet includes a notes region for recording the one or more notes.

24. A method according to claim 23 wherein the new account worksheet also includes a script region for displaying the predetermined script.

25. A method according to claim 23 wherein the new account worksheet is associated with the particular representative of the organization that initiates the prospective client contact.

26. A method according to claim 23 wherein the new account worksheet includes a selection indicator to add the prospective client to the DNC listing.

27. A method for identifying prospective clients using a Do Not Call (DNC) listing, the DNC listing identifying prospective clients that do not want to be called, the DNC listing being updated and released from time to time with the updated DNC listing having a number of newly added prospective clients, the updated DNC listing becoming effective a grace period after being released, the method comprising the steps of:
gaining access to an updated DNC listing after it is released but before the grace period expires;
identifying which of the prospective clients were newly added to the DNC listing;

28. A method according to claim 27 further comprising the step of:
contacting at least some of the identified newly added prospective clients before the grace period expires.

29. A method for identifying prospective clients using a Do Not Call (DNC) listing, the DNC listing identifying prospective clients that do not want to be called, the DNC listing being updated and released from time to time with the updated DNC listing having a number of prospective clients that are missing relative to a previous DNC listing, the method comprising the steps of:
gaining access to a previous DNC listing;
gaining access to an updated DNC listing; and
comparing the previous DNC listing with the updated DNC listing to identify those prospective clients that are missing from the updated DNC listing relative to the previous DNC listing.

30. A method according to claim 29 further comprising the step of:
contacting at least some of the identified prospective clients that are missing from the updated DNC listing relative to the previous DNC listing.

31. A method for controlling whether a prospective client should be contacted by a representative of an organization, the method comprising the steps of:
gaining access to one or more Do Not Call (DNC) listings, each DNC listing having a number of entries that identify prospective clients that do not want to be called, selected DNC listings have one or more exemptions that allow the DNC prospective clients identified by the DNC listing to be contacted by a representative of the organization;
providing a number of parameters that relate to selected exemptions, each of the parameters having one or more values associated therewith;
allowing the organization to set one or more of the values associated with selected parameters;
providing one or more prospective client identifiers each corresponding to a prospective client;
identifying which of the prospective clients, if any, have a prospective client identifier that includes a corresponding entry in at least one of the DNC listings, resulting in a number of identified DNC prospective clients; and
applying one or more of the values set by the organization to help identify which of the identified DNC prospective clients, if any, can be contacted by a representative of the organization.

32. A method according to claim 31 wherein two or more of the DNC listings have different defined exemptions.

33. A method according to claim 22 wherein selected parameters have one or more different values associated therewith.

34. A method according to claim 31 wherein the organization is a financial services organization with a compliance authority, and wherein the compliance authority sets the one or more values of selected parameters.
